(19) United States
(12) Patent Application Publication
(10) Pub. No.: US 2012/0153585 A1
(43) Pub. Date: Jun. 21, 2012

(54) Expandable and Convertible Hand Trucks

(75) Inventors: Paul Ryan, Wichita, KS (US); Robert A. Wood, Lincoln, NE (US)

(73) Assignee: DG Manufacturing, LLC

(21) Appl. No.: 13/328,938

(22) Filed: Dec. 16, 2011

Related U.S. Application Data
(60) Provisional application No. 61/424,421, filed on Dec. 17, 2010.

(51) Int. Cl. B62B 3/02

(52) U.S. Cl. 280/47.18

(57) ABSTRACT

A hand truck comprising: (1) a hand truck frame; (2) a nose plate that is disposed adjacent a lower end of the hand truck frame; (3) a plurality of primary wheels disposed adjacent the nose plate; (4) at least one secondary wheel that is disposed adjacent an upper end of the hand truck frame; and (5) an extension mechanism that is adapted to allow a user to selectively adjust the distance between the plurality of primary wheels and the at least one secondary wheel.

### CROSS-REFERENCE TO RELATED APPLICATIONS

This application claims the benefit of both U.S. design patent application 29/381,258, filed on Dec. 16, 2010 and entitled “Hand Truck”, and U.S. Provisional Application No. 61/424,421, entitled “Expandable and Convertible Hand Trucks,” filed Dec. 17, 2010, which are hereby incorporated herein by reference.

### BACKGROUND

Hand trucks are commonly used to move items that are too heavy or bulky to be moved manually. Hand trucks are advantageous because they can be used to move items in an upright position, which helps to maneuver the items in and through narrow spaces. They also allow users to transport items without manually lifting the full weight of the items.

One disadvantage associated with conventional hand trucks is that they aren't typically suitable for carrying multiple items that can't be safely or effectively stacked. Conventional hand trucks also require the user to maintain a heightened level of concentration as they move items from place to place because the user must continuously balance the hand truck's frame and load over its wheels while moving the items. Accordingly, there is a need for improved hand trucks that may, for example, address such issues.

### SUMMARY

A hand truck, comprising: (1) a hand truck frame, (2) a nose plate disposed adjacent a lower end of the hand truck frame, (3) a primary wheel assembly comprising at least one primary wheel disposed adjacent the nose plate, and (4) a secondary wheel assembly comprising at least one secondary wheel disposed adjacent an upper end of the hand truck frame. In particular embodiments, the hand truck is adapted to be selectively moved between: (1) a hand truck orientation in which: (a) the at least one primary wheel is positioned in contact with the support surface that is supporting the hand truck; (b) the secondary wheel assembly is spaced apart from the support surface; and (c) the hand truck is oriented to use the primary wheel assembly, but not the secondary wheel assembly to roll over the support surface; and (2) a cart orientation in which: (a) the at least one primary wheel is positioned in contact with the support surface; (b) the at least one secondary wheel is positioned in contact with the support surface; and (c) the hand truck is oriented to use both the primary wheel assembly and the secondary wheel assembly to roll over the support surface. In certain embodiments, the hand truck includes an extension mechanism for allowing a user to use the extension mechanism to selectively adjust a distance between the primary wheel assembly and the secondary wheel assembly.

A hand truck, comprising: (1) a hand truck frame, (2) a nose plate disposed adjacent a lower end of the hand truck frame, (3) a plurality of primary wheels disposed adjacent the nose plate, (4) at least one secondary wheel disposed adjacent an upper end of the hand truck frame, and (5) an extension mechanism. In particular embodiments, the extension mechanism is adapted to allow a user to selectively adjust a distance between the plurality of primary wheels and the at least one secondary wheel.

A hand truck, comprising: (1) a frame including a first frame member and a second frame member spaced laterally apart from the first frame member; (2) a nose plate disposed adjacent a lower end of the frame; (3) a plurality of primary wheels disposed adjacent the nose plate; (4) at least one secondary wheel disposed adjacent an upper end of the frame; and (5) an extension assembly. In particular embodiments, the extension assembly comprises: (1) a first elongated extension member slidably mounted with the first frame member; (2) a second elongated extension member slidably mounted with the second frame member; (3) a connecting member that connects a portion of the first extension member to a portion of the second extension member; and (4) a handle comprising a grip portion that is slidably mounted with the extension assembly. In certain embodiments, the extension assembly is adapted to slide between: (1) a first position in which the plurality of primary wheels are spaced apart a first distance from the at least one secondary wheel, and (2) a second, extended position in which the plurality of primary wheels are spaced apart from the at least one secondary wheel by a second distance that is greater than the first distance. In particular embodiments, the handle is configured to selectively slide between: (1) a first position in which the grip portion is spaced a first distance from the nose plate, and (2) a second, extended position in which the grip portion is spaced a second distance from the nose plate that is greater than the first distance.

### BRIEF DESCRIPTION OF THE DRAW INGS

Having thus described various embodiments of the invention in general terms, reference will be now be made to the accompanying drawings, which are not necessarily drawn to scale, and wherein:

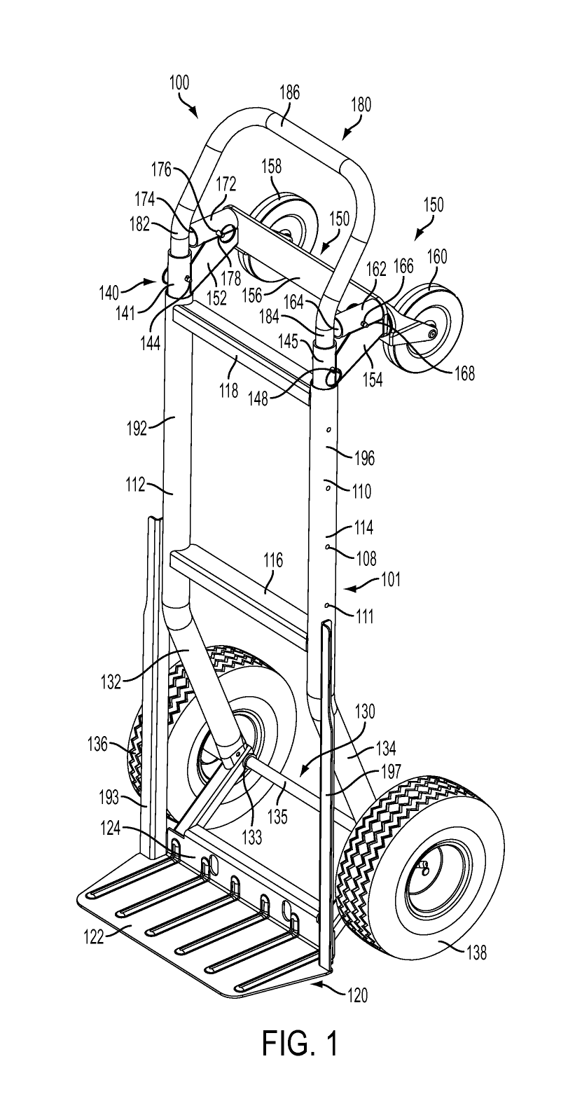

FIG. 1 is a front perspective view of an expandable, convertible hand truck according to a first particular embodiment of the disclosed subject matter. In this figure, the hand truck is shown in a substantially vertical, hand truck configuration.

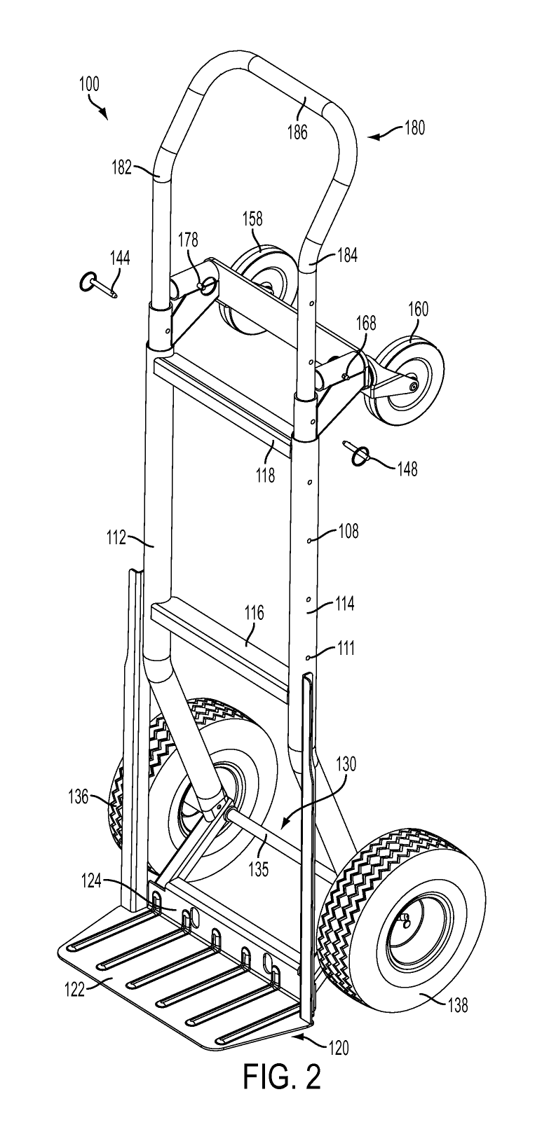

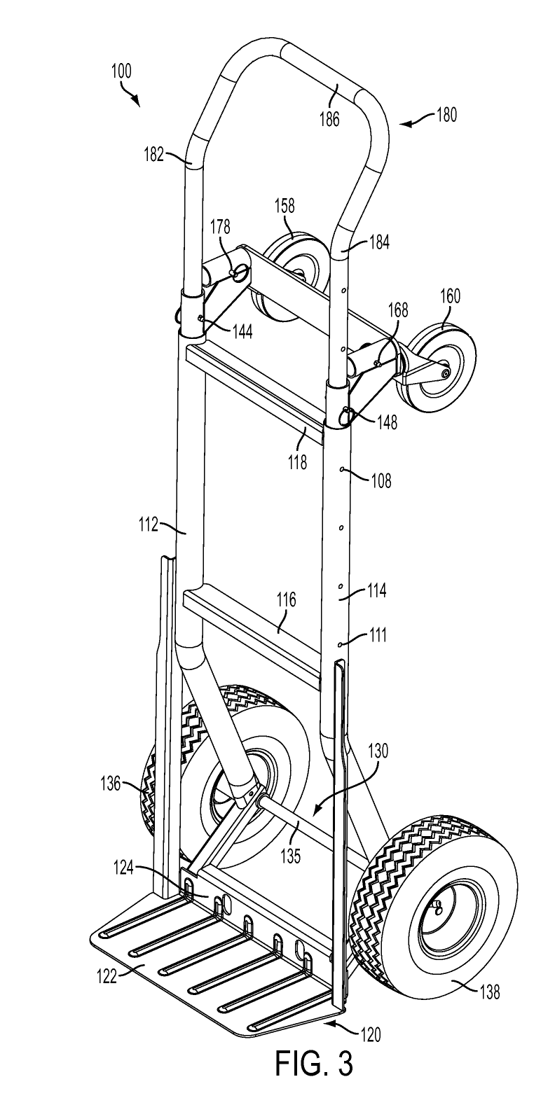

FIGS. 2 and 3 are front perspective views of the hand truck of FIG. 1 in which the hand truck's handle is in an extended position.

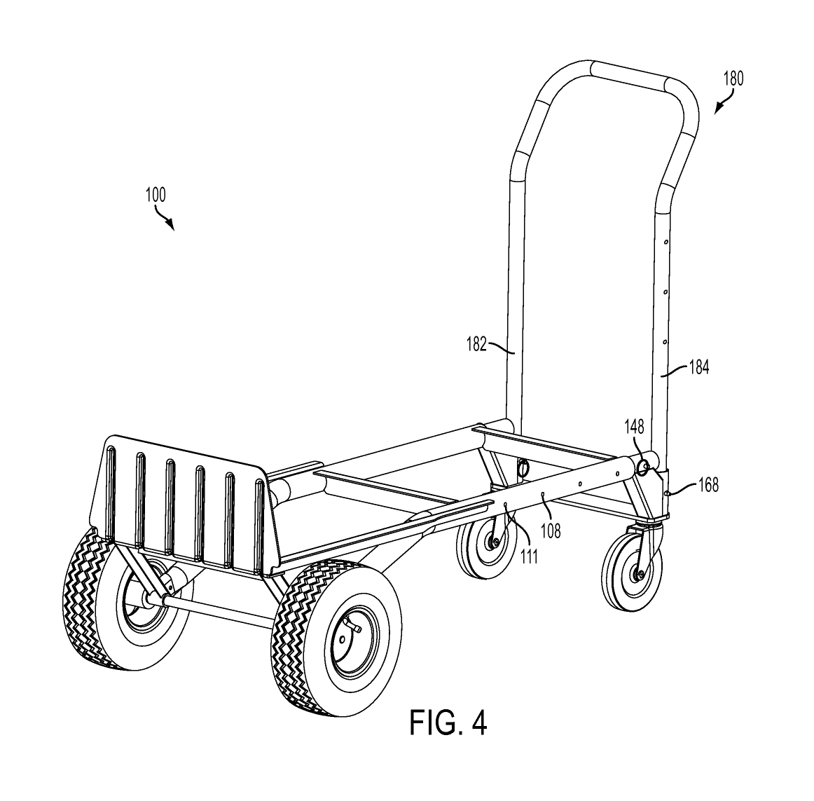

FIG. 4 is a front perspective view of the hand truck shown in FIG. 1 in which the hand truck is shown in a platform cart configuration.

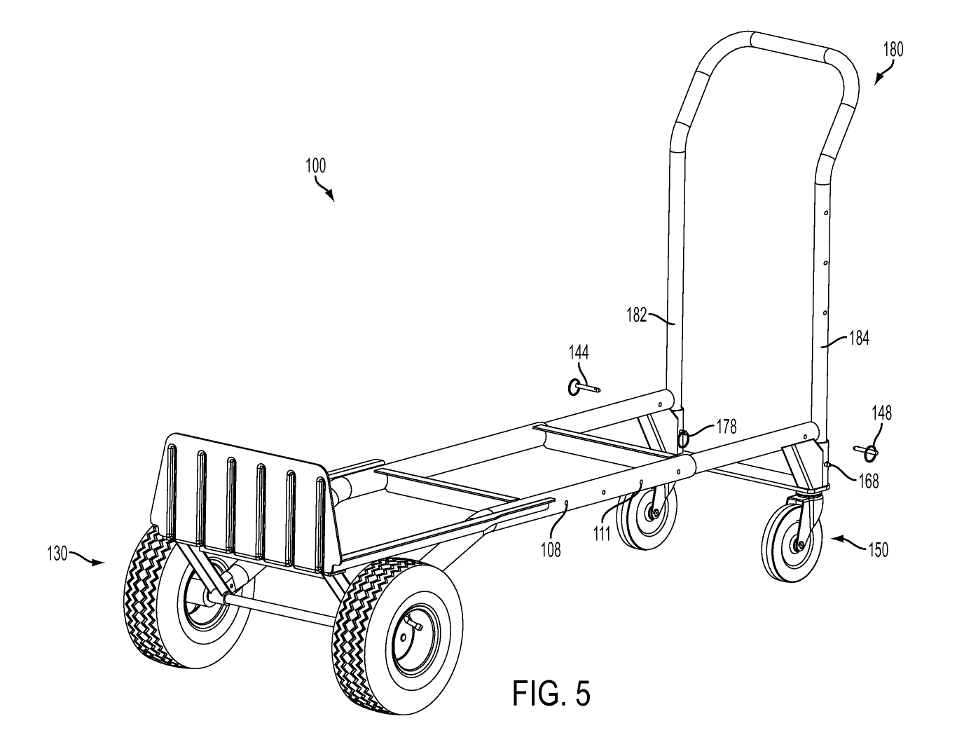

FIG. 5 is a front perspective view of the hand truck shown in FIG. 4 in which the hand truck is shown in an extended platform cart configuration.

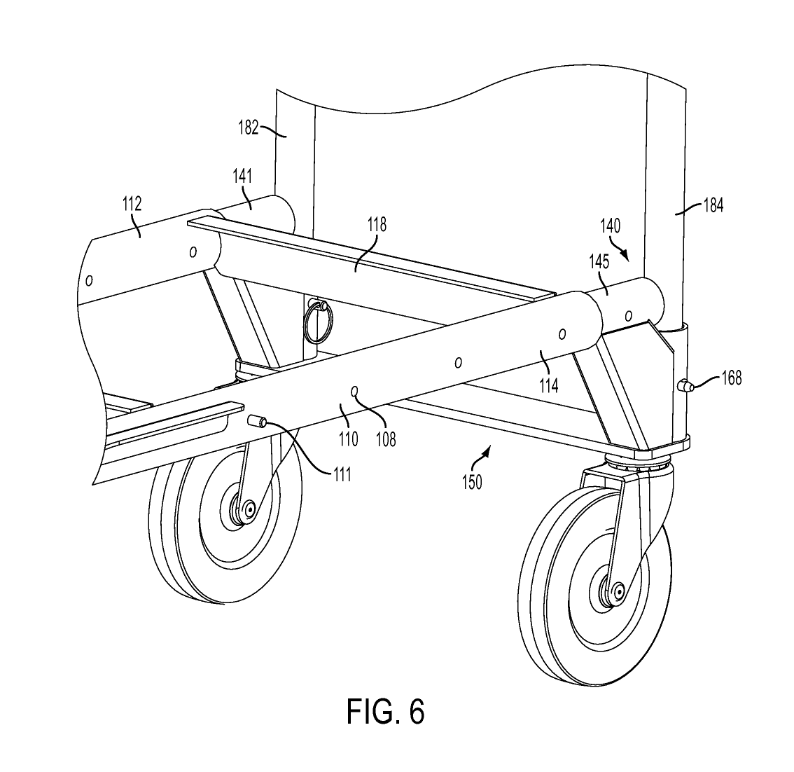

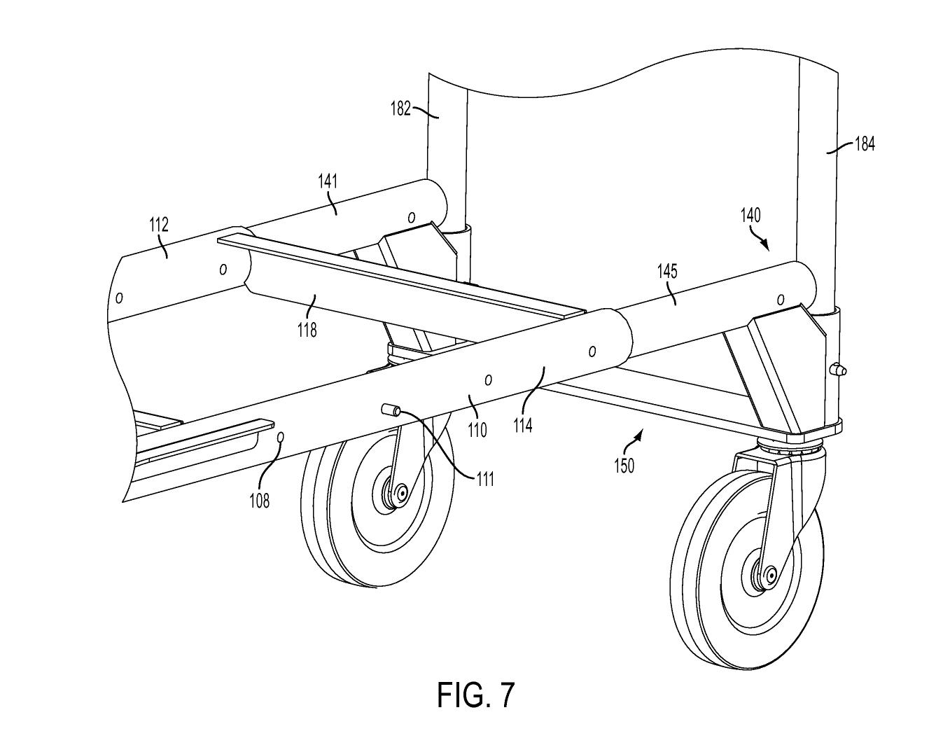

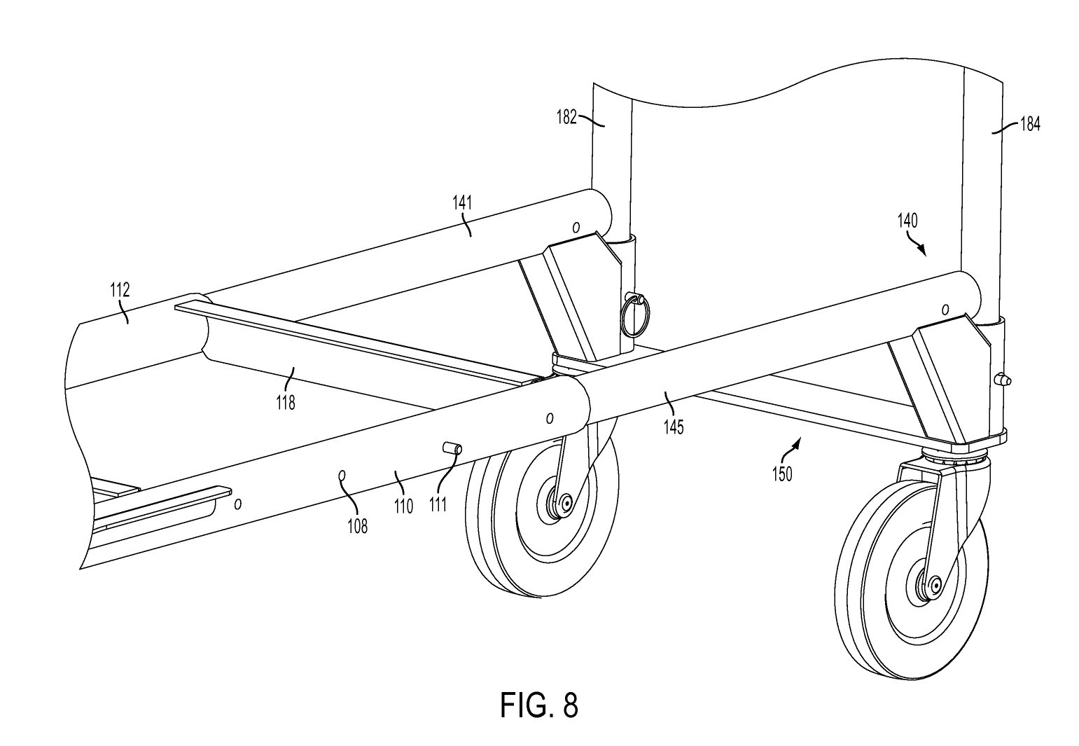

FIGS. 6-8 are close up views of a locking mechanism that may be used to maintain a hand truck, such as the hand truck of FIG. 1, in a particular extended or unextended orientation. These figures show the hand truck being gradually extended.

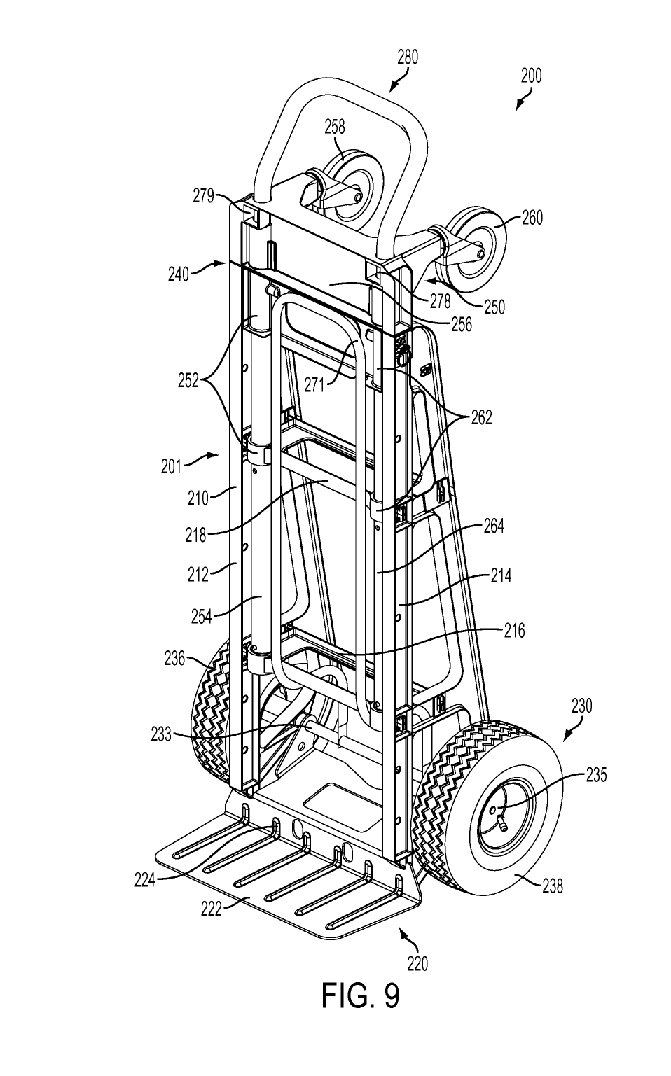

FIG. 9 is a front perspective view of a hand truck according to a second embodiment in which the hand truck is shown in a hand truck configuration.

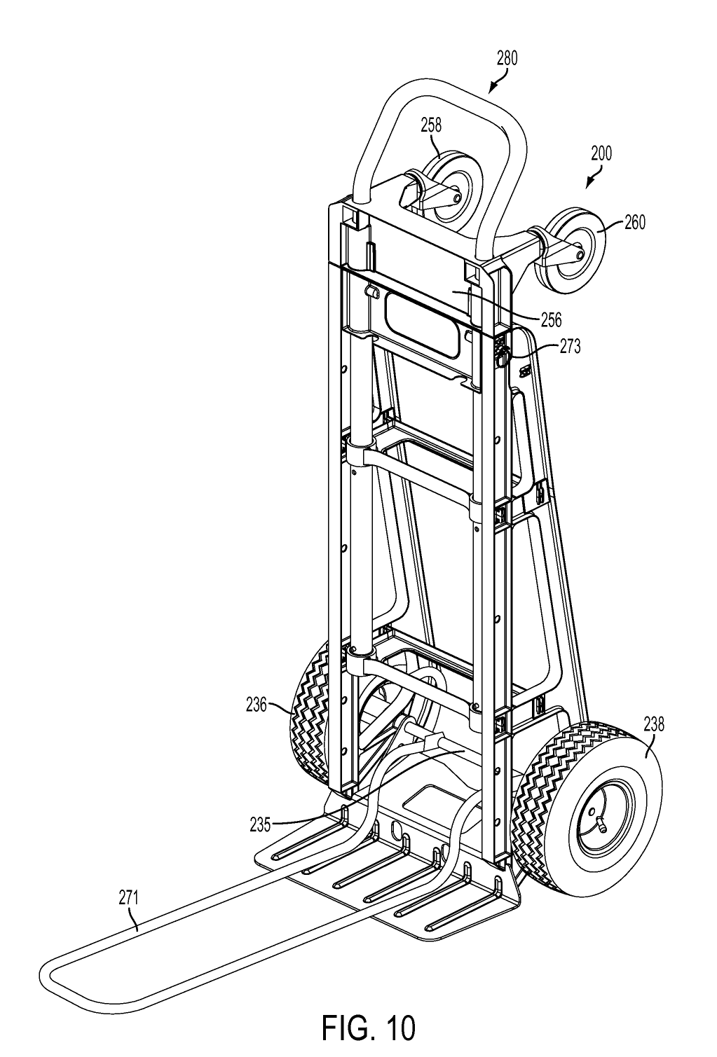

FIG. 10 is a front perspective view of the hand truck of FIG. 9 in which the hand truck's lower handle is in an extended orientation.

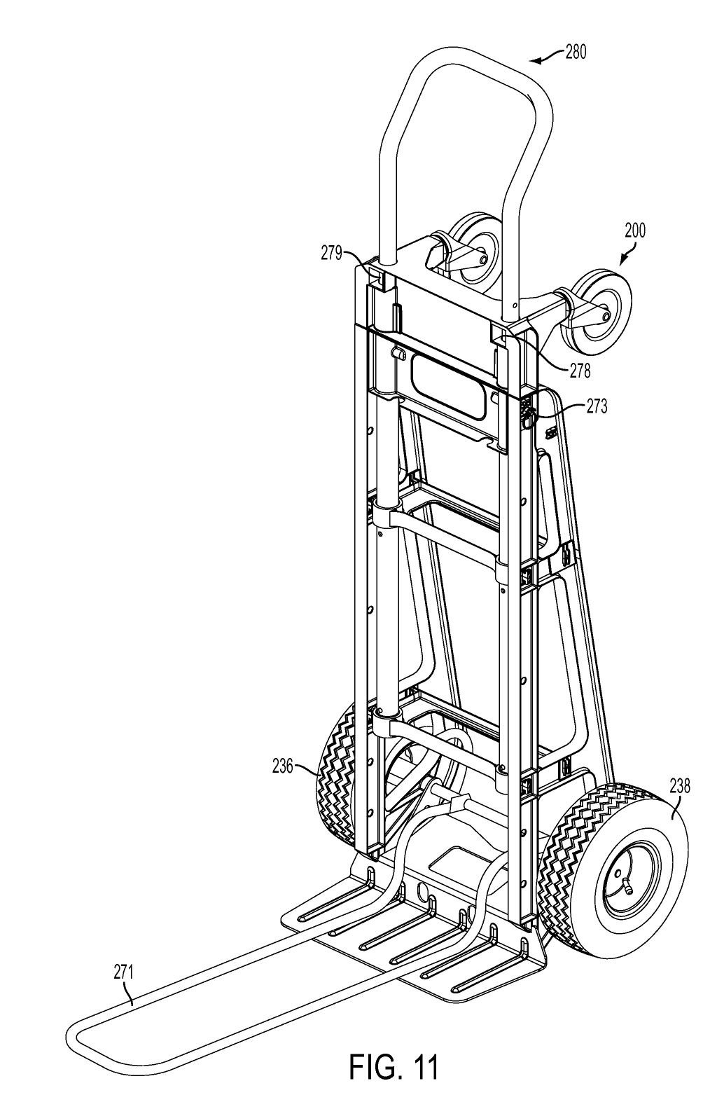

FIG. 11 is a front perspective view of the hand truck of FIG. 9 in which the hand truck's upper handle is in an extended orientation.

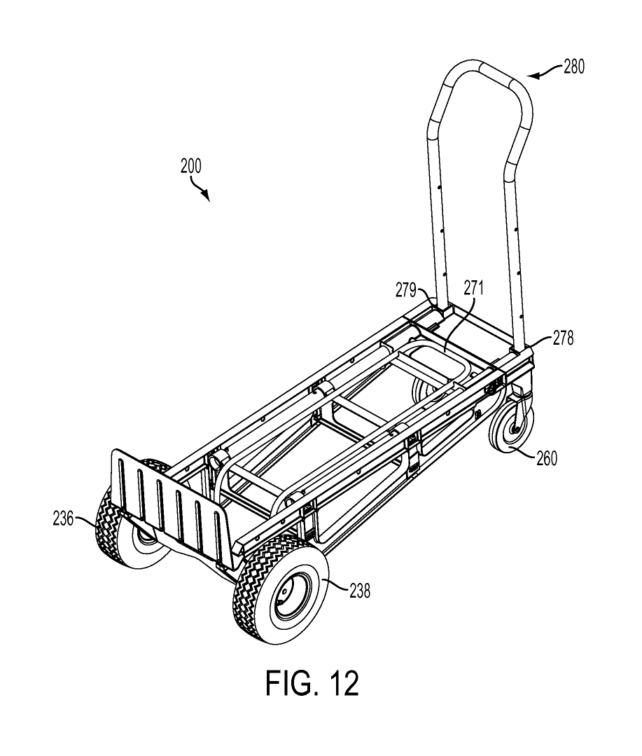

FIG. 12 is a front perspective view of an expandable, convertible hand truck according to a second particular embodiment of the disclosed subject matter. In this figure, the hand truck is shown in an unextended platform cart configuration.

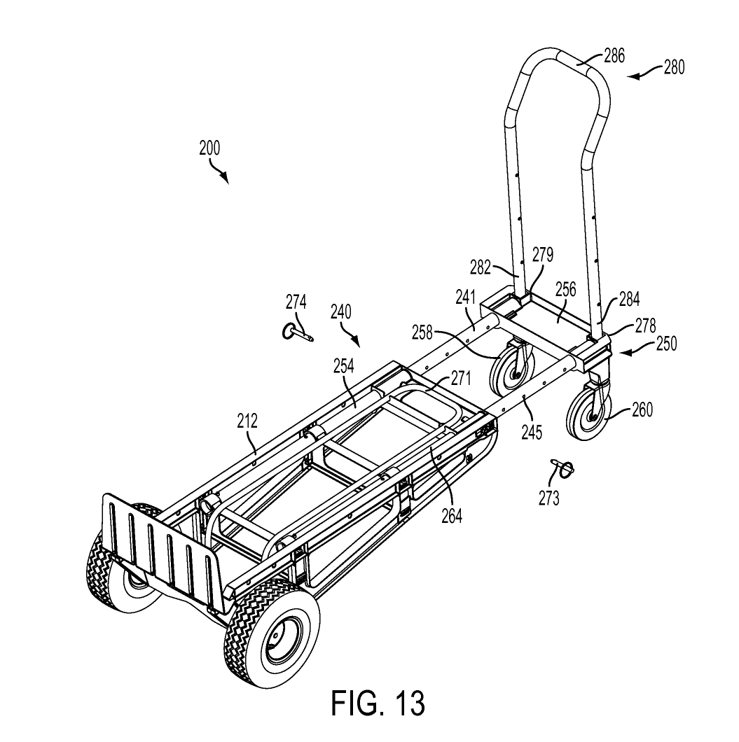

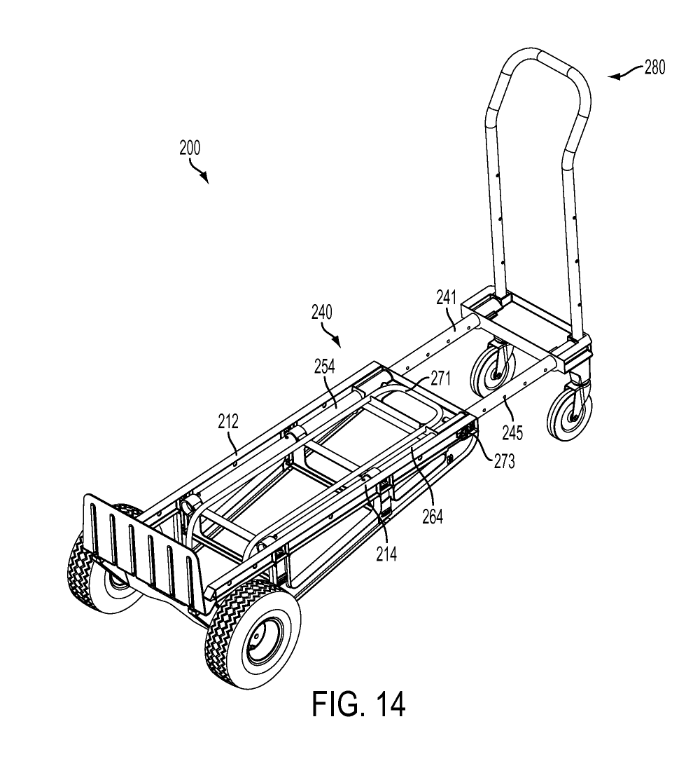

FIGS. 13-14 are front perspective views of the hand truck of FIG. 9 in which the hand truck is shown in an extended platform cart configuration.

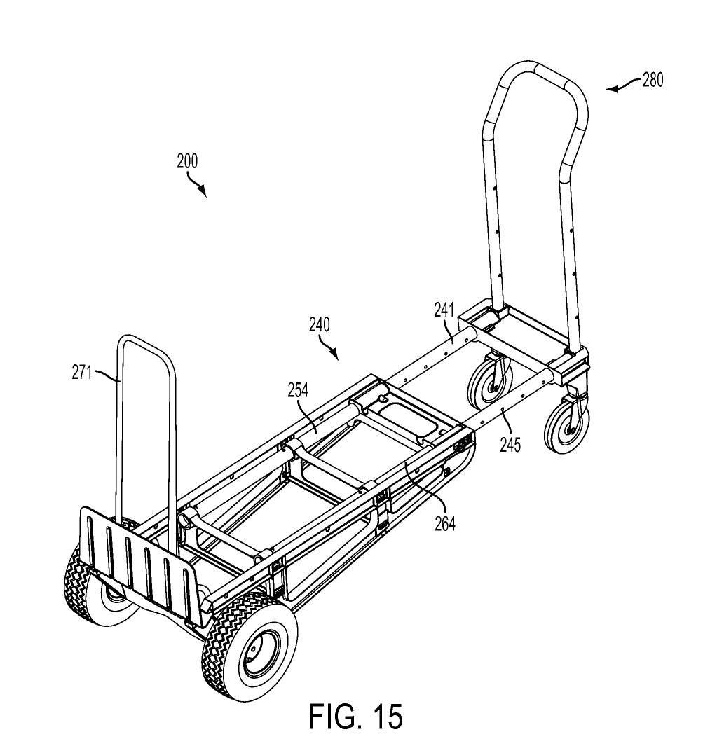

FIG. 15 is a front perspective view the hand truck of FIG. 9 in which the hand truck's lower handle is in an extended orientation.

### DETAILED DESCRIPTION OF VARIOUS EMBODIMENTS

Various embodiments of the disclosed subject matter will now be described more fully hereinafter with reference to the accompanying drawings, in which various embodiments of the disclosed subject matter are shown. The claimed technology may, however, be embodied in many different forms and should not be construed as limited to the embodiments set forth herein. Rather, these embodiments are provided so that this disclosure will be thorough and complete, and will fully convey the scope of the technology to those skilled in the art. Like numbers refer to like elements throughout.

### Expandable Hand Truck

An expandable hand truck 100 according to a particular embodiment is shown in FIGS. 1-8. In this embodiment, the hand truck 100 comprises: (1) a hand truck base portion 101; (2) an extendable frame assembly 140; (3) a secondary wheel assembly 150; and (4) an upper cart handle 180. These components are discussed in greater detail below.

Hand Truck Base Portion

In particular embodiments, the hand truck base portion 101 may comprise: (1) a frame 110; (2) a nose plate 120; and (3) a primary wheel assembly 130. These components are discussed in greater detail below.

1. Frame

The hand truck base portion 101 may include any suitable type of frame. In the embodiment shown in FIG. 1, this frame 110 includes: (1) a right frame member 112 (which, in this embodiment, is a substantially straight, elongated frame member, which comprises an upper portion 192 and a lower portion 193, and which is adapted to stand in a substantially vertical orientation when the hand truck base portion 101 is in an upright orientation); (2) a left frame member 114, which, in this embodiment, is a substantially straight, elongated frame member, which comprises an upper portion 196 and a lower portion 197, and which is adapted to stand in a substantially vertical orientation when the hand truck base portion 101 is in an upright orientation); and (3) a plurality of crossbars 116, 118 that extend between, and physically connect, the right and left frame members 112, 114.

The various components of the frame 110 may be made of any suitable (preferably sturdy) material (e.g., a suitable metal such as steel or aluminum, or plastic). In various embodiments, these components are secured together using any suitable fastening technique to provide a rigid frame for the hand truck.

2. Nose Plate

The hand truck base portion 101 may include any suitable type of nose plate 120. As shown in FIG. 1, this nose plate 120 may include: (1) a substantially planar support plate 122; and (2) a substantially planar face plate 124 that extends upwardly adjacent a rear edge of the support plate 122. The nose plate 120 is adapted to support a load and may be attached adjacent (e.g., to) a lower end of the hand truck base portion's frame 110 in any suitable manner (e.g., using suitable fasteners or welding techniques).

3. Primary Wheel Assembly

In particular embodiments, the hand truck's primary wheel assembly 130 is adapted for facilitating the movement of the hand truck 100 relative to a support surface that is supporting the hand truck 100. In the embodiment shown in FIG. 1, the primary wheel assembly 130 includes a substantially L-shaped right axle support 132 that extends outwardly and rearwardly adjacent the lower end of the right frame member's upper portion 192, and a substantially L-shaped left axle support 134 that extends outwardly and rearwardly adjacent (e.g., to) the lower end of the left frame member's upper portion 196. The right axle support 132 defines an opening 133 adjacent an apex formed by the right axle support 132, and the left axle support 134 defines a similar opening (not shown) that is adjacent an apex formed by the left axle support 134.

The primary wheel assembly 130 may further include an elongated hand truck axle 135 (see FIG. 1) that extends through the openings 133 in the right and left axle supports 132, 134 so that the axle 135 is substantially parallel to a support surface that supports the hand truck 100 when the hand truck base portion 101 is in an upright orientation. The primary wheel assembly 130 further includes a pair of wheels 136, 138 that are rotatably mounted, respectively, adjacent (e.g., to) opposite ends of the hand truck's axle 135.

Extendable Frame Assembly

In particular embodiments, the extendable frame assembly 140 is adapted for facilitating the selective conversion of the hand truck 100 between: (1) an unextended configuration and (2) an extended configuration. In the embodiment of FIG. 1, this extendable frame assembly 140 includes: (1) a right extendable frame member 141; (2) a left extendable frame member 145; and (3) a connecting member that connects the right and left extendable frame members 141, 145. These various components are discussed in greater detail below.

1. Right Extendable Frame Member

As shown in FIG. 1, the right extendable frame member 141 may comprise an elongated tube (e.g., a tube having a cross-section that, for example, may be substantially in the shape of a square, circle, oval, or any other suitable shape). The right extendable frame member 141 may be made of any suitable (preferably sturdy) material (e.g., a suitable metal such as steel or aluminum, or plastic).

As shown in FIG. 1, the right extendable frame member 141 may be adapted to fit within the upper portion 192 of the frame's right frame member 112 (which may be, for example, a hollow tube, or other suitable structure). In various embodiments, the inner cross-sectional profile of the upper portion 192 of the right frame member 112 at least substantially corresponds to an outer cross-sectional profile of the right extendable frame member 141. In particular embodiments, the right extendable frame member 141 has an outer diameter that is substantially equal to an inner diameter of the upper portion 192 of the right frame member 112. The respective diameters of the right extendable frame member 141 and upper portion 192 of the right frame member 112 may be chosen to allow the right extendable frame member 141 to translate within the upper portion 192 of the right frame member 112 while maintaining the right extendable frame member 141 in a substantially parallel configuration with the left extendable frame member 145 (e.g., while maintaining a tight fit—e.g., a mating fit—between the right extendable frame member 141 and the upper portion 192 of the right frame member 112).

2. Left Extendable Frame Member

As shown in FIG. 1, the left extendable frame member 145 may comprise an elongated tube (e.g., a tube having a cross-section that, for example, may be substantially in the shape of a square, circle, oval, or any other suitable shape). The left extendable frame member 145 may be made of any suitable (preferably sturdy) material (e.g., a suitable metal such as steel or aluminum, or plastic).

As shown in FIG. 1, the left extendable frame member 145 may be adapted to fit within the upper portion 196 of the frame's left frame member 114 (which may be, for example, a hollow tube, or other suitable structure). In various embodiments, the inner cross-sectional profile of the upper portion 196 of the left frame member 114 at least substantially corresponds to an outer cross-sectional profile of the left extendable frame member 145. In particular embodiments, the left extendable frame member 145 has an outer diameter that is substantially equal to an inner diameter of the upper portion 196 of the left frame member 114. The respective diameters of the left extendable frame member 145 and upper portion 196 of the left frame member 114 may be chosen to allow the left extendable frame member 145 to translate within the upper portion 196 of the left frame member 114 while maintaining the left extendable frame member 145 in a substantially parallel configuration with the right extendable frame member 141 (e.g., while maintaining a tight fit—e.g., a mating fit—between the left extendable frame member 145 and the upper portion 196 of the left frame member 114).

3. Connecting Member

In particular embodiments, the extendable frame assembly 140 comprises a connecting member that, in various embodiments, provides a rigid connection between the upper ends of the right and left extendable frame members 141, 145. In the embodiment shown in FIG. 1, the secondary wheel assembly 150 serves this purpose. However, in other embodiments, another suitable structure may serve in this role.

Secondary Wheel Assembly

In particular embodiments, the expandable hand truck 100 may further comprise a secondary wheel assembly 150. As may be understood from FIGS. 4-5, in various embodiments, the secondary wheel assembly 150 is adapted for facilitating the movement of the hand truck 100 relative to a support surface supporting the hand truck while the hand truck 100 is in a horizontal orientation (e.g., while the hand truck is in a platform cart orientation). The secondary wheel assembly 150 may be adapted for cooperating with the primary wheel assembly 130 to facilitate a rolling movement of the hand truck 100 over the support surface.

In various embodiments, the secondary wheel assembly 150 comprises at least one wheel that is rotatably attached adjacent the extendable frame assembly 140. For example, in the embodiment shown in FIGS. 1-8, the secondary wheel assembly 150 comprises a pair of secondary wheels 158, 160 (in this case, a pair of caster wheels). As shown in FIG. 1, the secondary wheel assembly 150 may be attached, for example, adjacent the extendable frame assembly 140 (e.g., adjacent the right and left extendable frame members 141, 145).

As may be understood from FIG. 1, in particular embodiments, the secondary wheel assembly 150 comprises a substantially planar central support 156 that is positioned behind an upper portion of the hand truck 100. In particular embodiments, the central support 156 is substantially parallel to the hand truck's front face. In the embodiment shown in in FIG. 1, the lateral sides of the central support 156 generally align with respective lateral sides of the hand truck 100.

In various embodiments, the secondary wheel assembly 150 further includes a substantially planar (e.g., rigid) right connector 152 that extends between the right extendable frame member 141 and the right lateral side of the central support 156. Similarly, the secondary wheel assembly 150 also includes a substantially planar (e.g., rigid) left connector 154 that extends between the left extendable frame member 145 and the left lateral side of the central support 156.

In particular embodiments, such as the embodiment of FIG. 1, the secondary wheel assembly 150 includes a left handle support 162 that extends outwardly from a front surface of the central support 156 adjacent the central support's left lateral side. The left handle support 162 defines an interior portion that is adapted for snuggly receiving a lower end of a left handle portion 184 of the hand truck's handle 180 (e.g., through an opening 164 in a distal end of the left handle support 162). As shown in FIG. 1, the left handle support may extend outwardly from the front surface of the central support 156 (e.g., at an angle of about 90 degrees from the front surface of the central support 156).

In the embodiment of FIG. 1, the secondary wheel assembly 150 also includes a right handle support 172 that extends outwardly from a front surface of the central support 156 adjacent the central support's right lateral side. In particular embodiments, the right handle support 172 defines an interior portion that is adapted for snuggly receiving a lower end of a right handle portion 182 of the hand truck's handle 180 (e.g., through an opening 174 in a distal end of the right handle support 172). The right handle support 172 may extend outwardly from the front surface of the central support 156 (e.g., at an angle of about 90 degrees from the front surface of the central support 156). In various embodiments, such as the embodiment of FIG. 1, the right and left handle supports 172, 162 are adapted to cooperate to maintain the hand truck's handle 180 in an orientation that is substantially parallel to the hand truck's nose plate 120.

As shown in FIG. 1, the right and left handle supports 172, 162 may include suitable locking mechanisms for maintaining the ends of the hand truck's handle 180 in a substantially fixed position relative to the hand truck's handle supports 172, 162. One suitable locking mechanism may be, for example, a pin 168, 178 that extends through an opening 166, 176 in one of the hand truck's handle supports 172, 162 and then through a corresponding hole in a side portion of a respective end of the hand truck's handle 180. Although the locking mechanism is shown as a pin arrangement in FIG. 1, any other suitable locking mechanism may be used for this purpose.

As shown in FIG. 1, in particular embodiments, the right and left handle supports 172, 162 are spaced apart from each other by a distance corresponding to the distance between the right and left handle portions 182, 184 of the upper cart handle 180. The exact length of this spacing may vary, for example, from model to model.

Upper Cart Handle

The hand truck 100 may include any suitable type of upper cart handle 180. As shown in FIG. 1, the upper cart handle 180 may comprise a substantially U-shaped piece of metal tubing. In the embodiment shown in FIG. 1, the upper cart handle 180 comprises: (1) a right handle portion 182; (2) a left handle portion 184; and (3) a central handle portion 186.

The right handle portion 182 may comprise a substantially straight, elongated tube having, for example, a substantially circular (e.g., circular) profile. In alternative embodiments, the right handle portion 182 may have any other suitable profile (e.g., a square, rectangular, or oval profile). As shown in FIG. 1, the right handle portion 182 may be adapted to fit and slide within the right extendable frame member 141. In various embodiments, the right handle portion 182 has a cross sectional profile that at least generally corresponds to the cross sectional profile of the right extendable frame member 141. The dimensions of the inner surface of the right extendable frame member 141 may substantially correspond to (e.g., correspond to) the dimensions of the outer surface of the right handle portion 182 such that the right handle portion 182 can nest within the right extendable frame member 141 with sufficient clearance to facilitate smooth sliding and sufficient snugness to provide rigidity of the hand truck 100 when the upper cart handle 180 is in an extended position.

In particular embodiments, the right extendable frame member 141 is adapted to fit and slide within the right frame member 112. As may be understood from FIG. 1, when the right handle portion 182 is nested within the right extendable frame member 141 and the right extendable frame member 141 is nested within the right frame member 112, the right handle portion 182, the right extendable frame member 141, and the right frame member 112 are maintained in a triple nested relationship with one another.

In various embodiments, the left handle portion 184 may comprise a substantially straight, elongated tube having, for example, a substantially circular (e.g., circular) profile. In alternative embodiments, the left handle portion 184 may have any other suitable profile (e.g., a square, rectangular, or oval profile). As shown in FIG. 1, the left handle portion 184 may be adapted to fit and slide within the left extendable frame member 145. In various embodiments, the left handle portion 184 has a cross sectional profile that corresponds to the cross sectional profile of the left extendable frame member 145. The dimensions of the inner surface of the left extendable frame member 145 may substantially correspond to (e.g., correspond to) the dimensions of the outer surface of the left handle portion 184 such that the left handle portion 184 can nest within the left extendable frame member 145 with sufficient clearance to facilitate smooth sliding and sufficient snugness to provide rigidity of the hand truck 100 when the upper cart handle 180 is in an extended position.

In particular embodiments, the left extendable frame member 145 is adapted to fit and slide within the left frame member 114. As may be understood from FIG. 1, when the left handle portion 184 is nested within the left extendable frame member 145 and the left extendable frame member 145 is nested within the left frame member 114, the left handle portion 184, the left extendable frame member 145, and the left frame member 114 are maintained in a triple nested relationship with one another.

As shown in FIGS. 6-8, one or more spring-loaded buttons 111 may be used to selectively lock the hand truck's frame members in place at different positions relative to the hand truck's frame 110. Each spring loaded button 111 may include a spring that is adapted for biasing the button 111 away from the spring and through one or more holes 108 in the frame 110. In alternative embodiments, any other suitable locking mechanism may be used in place of the spring loaded buttons.

As shown in FIGS. 1-3, the upper cart handle 180 is adapted for selective extension and retraction relative to the hand truck's base portion 101. FIG. 1 shows a particular embodiment of a hand truck 100 with the upper cart handle 180 in a retracted position. FIG. 3 shows a particular embodiment of a hand truck 100 with the upper cart handle 180 in an extended position. In various embodiments, the upper cart handle 180 further comprises a locking mechanism for locking the upper cart handle 180 at various lengths of extension. In the embodiment shown in FIGS. 1-3, the locking mechanism includes pins 144, 148 that lock the upper cart handle 180 in place. Other embodiments may include any other suitable locking mechanism.

### Alternative Embodiments

An alternative embodiment of the hand truck is shown in FIGS. 9-15. In this embodiment, much of the hand truck 200 may, for example, be made of a composite material (e.g., plastic). However the basic structure and functionality of the hand truck 200 is similar to that of the hand truck 100 shown in FIGS. 1-8. For example, the embodiment of the hand truck 200 shown in FIGS. 9-15 includes: (1) a hand truck base portion 201; (2) an extendable frame assembly 240; (3) a secondary wheel assembly 250; (4) an upper cart handle 280; and (5) a lower cart handle 271. These various components are discussed in greater detail below.

Hand Truck Base Portion

In particular embodiments, the hand truck base portion 201 may comprise: (1) a frame 210; (2) a nose plate 220; and (3) a primary wheel assembly 230. These various components are discussed in greater detail below.

1. Frame

The hand truck base portion 201 may include any suitable type of frame. In the embodiment shown in FIG. 9, this frame 210 includes: (1) a right frame member 212 (which, in this embodiment, is in the form of a substantially planar, substantially triangular truss, which is adapted to stand in a substantially vertical orientation when the hand truck base portion 201 is in an upright orientation); (2) a left frame member 214, which, in this embodiment, is also a substantially planar, substantially triangular truss, which is adapted to stand in a substantially vertical orientation when the hand truck base portion 201 is in an upright orientation); and (3) a plurality of crossbars 216, 218 that extend between, and physically connect, the right and left frame members 212, 214.

The various components of the frame 210 may be made of any suitable (preferably sturdy) material (e.g., a suitable metal such as steel or aluminum, or plastic). In various embodiments, these components are secured together using any suitable fastening technique to provide a rigid frame for the hand truck.

2. Nose Plate

The hand truck base portion 201 may include any suitable type of nose plate 220. As shown in FIG. 6, this nose plate 220 may include: (1) a substantially planar support plate 222; and (2) a substantially planar face plate 224 that extends upwardly adjacent a rear edge of the support plate 222. The nose plate 220 is adapted to support a load and may be attached adjacent (e.g., to) a lower end of the hand truck base portion's frame 210 in any suitable manner (e.g., using suitable fasteners or welding techniques).

3. Primary Wheel Assembly

In particular embodiments, the hand truck's primary wheel assembly 230 is adapted for facilitating the movement of the hand truck 200 relative to a support surface that is supporting the hand truck 200. In the embodiment shown in FIG. 9, the primary wheel assembly 230 includes an axle support that includes one or more bearings that may be, for example, attached adjacent, or integrated into, the structure of the right and left frame members 212, 214. In the embodiment shown in FIG. 9, the right and left frame members 212, 214 each include a bearing 233 that defines an opening that is dimensioned for receiving an axle 235 that extends through the opening.

The primary wheel assembly 230 may further include an elongated hand truck axle 235 (See FIGS. 9 and 10) that extends through the openings in the right and left bearings 233 so that the axle 235 is substantially parallel to a support surface that supports the hand truck 200 when the hand truck base portion 201 is in an upright orientation. The primary wheel assembly 230 further includes a pair of wheels 236, 238 that are rotatably mounted, respectively, adjacent (e.g., to) opposite ends of the hand truck's axle 235.

Extendable Frame Assembly

In particular embodiments, the extendable frame assembly 240 is adapted for facilitating the selective conversion of the hand truck 200 between: (1) an unextended configuration and (2) an extended configuration. In the embodiment of FIGS. 9-15, this extendable frame assembly 240 includes: (1) a right extendable frame member 241 (see FIG. 15); (2) a left extendable frame member 245; and (3) a connecting member that connects the right and left extendable frame members 241, 245 together. These various components are discussed in greater detail below.

1. Right Extendable Frame Member

As shown in FIG. 13, the right extendable frame member 241 may comprise an elongated tube (e.g., a tube having a cross-section that, for example, may be substantially in the shape of a square, circle, oval, or any other suitable shape). The right extendable frame member 241 may be made of any suitable (preferably sturdy) material (e.g., a suitable metal such as steel or aluminum, or plastic).

As shown in FIG. 13, the right extendable frame member 241 may be adapted to fit within a first hollow tube 254 (or other suitable structure) that is attached adjacent an interior portion of the frame's right frame member 212 (e.g., via one or more suitable O or C shaped supports 252). As shown in FIG. 13, the inner cross-sectional profile of the first hollow tube 254 may at least substantially correspond to an outer cross-sectional profile of the right extendable frame member 241. In particular embodiments, the right extendable frame member 241 has an outer diameter that is substantially equal to an inner diameter of the first hollow tube 254. The respective diameters of the right extendable frame member 241 and first hollow tube 254 may be chosen to allow the right extendable frame member 241 to translate within the first hollow tube 254 while maintaining the right extendable frame member 241 in a substantially parallel configuration with the first hollow tube 254 (e.g., while maintaining a tight fit—e.g., a mating fit—between the right extendable frame member 241 and the first hollow tube 254).

2. Left Extendable Frame Member

As shown in FIG. 14, the left extendable frame member 245 may comprise an elongated tube (e.g., a tube having a cross-section that, for example, may be substantially in the shape of a square, circle, oval, or any other suitable shape). The left extendable frame member 245 may be made of any suitable (preferably sturdy) material (e.g., a suitable metal such as steel or aluminum, or plastic).

As shown in FIG. 14, the left extendable frame member 245 may be adapted to fit within a second hollow tube 264 (or other suitable structure) that is attached adjacent an interior portion of the frame's left frame member 214 (e.g., via one or more suitable O or C shaped supports 262). As shown in FIG. 14, the inner cross-sectional profile of the second hollow tube 264 may at least substantially correspond to an outer cross-sectional profile of the left extendable frame member 245. In particular embodiments, the left extendable frame member 245 has an outer diameter that is substantially equal to an inner diameter of the second hollow tube 264 of the left frame member 214. The respective diameters of the left extendable frame member 245 and second hollow tube 264 may be chosen to allow the left extendable frame member 245 to translate within the second hollow tube 264 while maintaining the left extendable frame member 245 in a substantially parallel configuration with the second hollow tube 264 (e.g., while maintaining a tight fit—e.g., a mating fit—between the left extendable frame member 245 and the second hollow tube 264).

3. Connecting Member

In particular embodiments, the extendable frame assembly 240 comprises a connecting member that, in various embodiments, provides a rigid connection between the upper ends of the right and left extendable frame members 241, 245. In the embodiment shown in FIG. 13, the secondary wheel assembly 250 serves this purpose. However, in other embodiments, another suitable structure may serve in this role.

Secondary Wheel Assembly

In particular embodiments, the expandable hand truck 200 comprises a secondary wheel assembly 250. In the embodiment shown in FIG. 13, the secondary wheel assembly 250 is adapted for facilitating the movement of the hand truck 200 relative to a support surface supporting the hand truck 200 while the hand truck 200 is in a horizontal orientation (e.g., while the hand truck 200 is in a platform cart orientation, such as the orientation shown in FIG. 13). The secondary wheel assembly 250 may be adapted for cooperating with the primary wheel assembly 230 to facilitate a rolling movement of the hand truck 200 over the support surface.

In various embodiments, the secondary wheel assembly 250 comprises at least one wheel that is rotatably attached adjacent the extendable frame assembly 240. In the embodiment shown in FIG. 13, the secondary wheel assembly 250 comprises a pair of secondary wheels 258, 260 (in this case, a pair of caster wheels). As shown in FIG. 13, the secondary wheel assembly 250 may be attached, for example, to at least substantially rigidly connect the right and left extendable frame members 241, 245).

As may be understood from FIG. 13, in particular embodiments, the secondary wheel assembly 250 comprises a substantially planar central portion 256 that extends between the respective upper ends of the right and left extendable frame members 241, 245. In particular embodiments, the central support portion 256 is substantially parallel to the hand truck's front face. In the embodiment shown in in FIG. 13, the lateral sides of the secondary wheel assembly 250 generally align with respective lateral sides of the hand truck.

In particular embodiments, such as the embodiments of FIGS. 9 and 13, the secondary wheel assembly 250 includes a right handle support 279 that includes a recess defined by the secondary wheel assembly's central support portion 256 adjacent the central support's right lateral side. In particular embodiments, the right handle support 279 is adapted for snuggly receiving a lower end of a right handle portion 282 of the hand truck's handle 280.

In the embodiment of FIGS. 9 and 13, the secondary wheel assembly 250 also includes a left handle support 278 that includes a recess defined by the secondary wheel assembly's central support portion 256 adjacent the central support portion's left lateral side. In particular embodiments, the left handle support 278 is adapted for snuggly receiving a lower end of a left handle portion 284 of the hand truck's handle 280. In various embodiments, such as the embodiment of FIGS. 9 and 13, the left and right handle supports 278, 279 are adapted to cooperate to maintain the hand truck's handle 280 in an orientation that is substantially parallel to the hand truck's nose plate 220.

In various embodiments, the left and right handle supports 278, 279 may include suitable locking mechanisms for maintaining the ends of the hand truck's handle 280 in a substantially fixed position relative to the hand truck's handle supports 278, 279. One suitable locking mechanism may be, for example, a pin that extends through an opening in one of the hand truck's handle supports and then through a corresponding hole in a side portion of a respective end of the hand truck's handle 280. In other embodiments, the right and left handle supports 278, 279 and the hand truck's handle 280 may be dimensioned so that the frictional engagement between portions of the ends of the hand truck's handle 280 and the right and left handle supports 278, 279 is sufficient to maintain the handle 280 in the desired orientation.

As shown in FIG. 14, in particular embodiments, the left and right handle supports 278, 279 are spaced apart from each other by a distance corresponding to the distance between the right and left handle portions 282, 284 of the upper cart handle 280. The exact length of this spacing may vary, for example, from model to model.

Upper Cart Handle

The hand truck 200 may include any suitable type of upper cart handle 280. As shown in FIGS. 9-15, the upper cart handle 280 may comprise a substantially U-shaped piece of metal tubing. In the embodiment shown in FIG. 13, the upper cart handle 280 comprises: (1) a right handle portion 282; (2) a left handle portion 284; and (3) a central handle portion 286.

The right handle portion 282 may comprise a substantially straight, elongated tube having, for example, a substantially circular (e.g., circular) cross-sectional profile. In alternative embodiments, the right handle portion 282 may have any other suitable cross-sectional profile (e.g., a square, rectangular, or oval profile). As shown in FIG. 9-11, the right handle portion 282 may be adapted to fit and slide within the right extendable frame member 241. In various embodiments, the right handle portion 282 has a cross sectional profile that at least generally corresponds to the cross sectional profile of the right extendable frame member 241. The dimensions of the inner surface of the right extendable frame member 241 may substantially correspond to (e.g., correspond to) the dimensions of the outer surface of the right handle portion 282 such that the right handle portion 282 can nest within the right extendable frame member 241 with sufficient clearance to facilitate smooth sliding and sufficient snugness to provide rigidity of the hand truck 200 when the upper cart handle 280 is in an extended position.

In particular embodiments, the right extendable frame member 241 is adapted to fit and slide within the first tube 254. In various embodiments, when the right handle portion 282 is nested within the right extendable frame member 241, and the right extendable frame member 241 is nested within the first tube 254, the right handle portion 282, the right extendable frame member 241, and the first tube 254 are maintained in a triple nested relationship with one another.

Similarly, the left handle portion 284 may comprise a substantially straight, elongated tube having, for example, a substantially circular (e.g., circular) profile. In alternative embodiments, the left handle portion 284 may have any other suitable profile (e.g., a square, rectangular, or oval profile). As shown in FIG. 13, the left handle portion 284 may be adapted to fit and slide within the left extendable frame member 245. In various embodiments, the left handle portion 284 has a cross sectional profile that at least generally corresponds to the cross sectional profile of the left extendable frame member 245. The dimensions of the inner surface of the left extendable frame member 245 may substantially correspond to (e.g., correspond to) the dimensions of the outer surface of the left handle portion 284 such that the left handle portion 284 can nest within the left extendable frame member 245 with sufficient clearance to facilitate smooth sliding and sufficient snugness to provide rigidity of the hand truck 200 when the upper cart handle 280 is in an extended position.

In particular embodiments, the left extendable frame member 245 is adapted to fit and slide within the second tube 264. As may be understood from FIG. 11, when the left handle portion 284 is nested within the left extendable frame member 245 and the left extendable frame member 245 is nested within the second tube 264, the left handle portion 284, the left extendable frame member 245, and the second tube 264 are maintained in a triple nested relationship with one another.

In various embodiments, the upper cart handle 280 is adapted for selective extension and retraction relative to the hand truck's base portion 201. FIG. 9 shows a particular embodiment of a hand truck 200 with the upper cart handle 280 in a retracted position. FIG. 11 shows the hand truck 200 with the upper cart handle 280 in an extended position. In various embodiments, the upper cart handle 280 further comprises a locking mechanism for locking the upper cart handle 280 at various lengths of extension. In the embodiment shown in FIGS. 9-11, the locking mechanism may include pins 279, 273 that lock the upper cart handle 280 in place by passing through openings in the sidewall of the right and left handle portions 282, 284 and the right and left extendable frame members 241, 245. Other embodiments may include any other suitable locking mechanism.

Lower Cart Handle

As shown in FIGS. 9-15, the hand truck 200 may further include a lower cart handle 271 that may, for example, be useful in restricting the movement of larger loads that are supported by the hand truck 200. In particular embodiments, the lower cart handle 271 is substantially U-shaped and is rotatably mounted adjacent (e.g., to) the hand truck 200 to rotate from a retracted position shown in FIG. 14 (in which the lower cart handle 271 is substantially parallel to the hand truck's front face) to an extended position shown in FIG. 15 in which the lower cart handle 271 is substantially parallel to the hand truck's nose plate 220.

### Conversion and Extension of Hand Truck

As may be understood from FIGS. 1-4, to convert the hand truck 100 from a vertical operating arrangement (see FIG. 3) to the horizontal operating arrangement (see FIG. 4), a user may position the hand truck 100 adjacent a support surface so that the hand truck's primary wheels 136, 138 and secondary wheels 158, 160 are all in contact with the support surface. Once the hand truck 100 is in this horizontal operating arrangement, the user may: (1) remove the upper handle assembly 180 from the extendable frame assembly 140; (2) insert the handle assembly's right handle portion 182 into the right handle support 172; and (3) insert the left handle portion 184 into the left handle support 162.

The user may then selectively reposition the hand truck's extendable frame assembly 140 relative to its base portion 101 to adjust the length of the hand truck 100. This may, for example, allow the user to selectively move the hand truck 100 between a first configuration and a second, extended configuration. As noted above, the extendable frame assembly 140 may be selectively locked in an extended or unextended configuration with any suitable locking mechanism (e.g., a pin).

In various embodiments, similar techniques may also be used to selectively move the hand truck 100 between unextended and extended configurations while the hand truck 100 is in the upright, vertical operating arrangement.

### CONCLUSION

Many modifications and other embodiments will come to mind to one skilled in the art to which this invention pertains having the benefit of the teachings presented in the foregoing descriptions and the associated drawings. For example, as will be understood by one skilled in the relevant field in light of this disclosure, the invention may take form in a variety of different mechanical and operational configurations. Therefore, it is to be understood that the invention is not to be limited to the specific embodiments disclosed and that modifications and other embodiments are intended to be included within the scope of the appended exemplary concepts. Although specific terms are employed herein, they are used in a generic and descriptive sense only and not for the purposes of limitation.

What is claimed is:

1. A hand truck comprising:
a hand truck frame;
a nose plate disposed adjacent a lower end of the hand truck frame;
a primary wheel assembly comprising at least one primary wheel, the primary wheel assembly being disposed adjacent the nose plate; and
a secondary wheel assembly comprising at least one secondary wheel, the secondary wheel assembly being disposed adjacent an upper end of the hand truck frame, wherein:
the hand truck is adapted to be selectively moved between:
(A) a hand truck orientation in which:
the at least one primary wheel is positioned in contact with a support surface that is supporting the hand truck;
the secondary wheel assembly is spaced apart from the support surface; and
the hand truck is orientated to use the primary wheel assembly, but not the secondary wheel assembly, to roll over the support surface; and
(B) a cart orientation in which:
the at least one primary wheel is positioned in contact with a support surface that is supporting the hand truck;
the at least one secondary wheel is positioned in contact with the support surface; and
the hand truck is orientated to use both the primary wheel assembly and the secondary wheel assembly to roll over the support surface; and
the hand truck includes an extension mechanism for allowing a user to use the extension mechanism to selectively adjust a distance between the primary wheel assembly and the secondary wheel assembly.

2. The hand truck of claim 1, wherein:
when the hand truck is in the hand truck orientation, the hand truck frame is in a substantially vertical orientation; and
when the hand truck is in the cart orientation, the hand truck frame is in a substantially horizontal orientation.

3. The hand truck of claim 1, wherein the extension mechanism is adapted to allow a user to:
selectively adjust the distance between the primary wheel assembly and the secondary wheel assembly when the hand truck is in the hand truck orientation; and
selectively adjust the distance between the primary wheel assembly and the secondary wheel assembly when the hand truck is in the cart orientation.

4. The hand truck of claim 1, wherein:
the upper cart handle comprises a grip portion; and
the upper cart handle is mounted to slide between:
(A) a first position, in which the grip portion is spaced a first distance from the nose plate; and
(B) a second, extended position, in which the grip portion is spaced a second distance from the nose plate, the second distance being greater than the first distance.

5. The hand truck of claim 4, wherein:
at least a particular portion of the upper cart handle is slideably mounted, in a nested relationship, with a particular portion of the extension mechanism.

6. The hand truck of claim 5, wherein the particular portion of the extension mechanism is substantially tubular.

7. The hand truck of claim 5, wherein the portion of the upper cart handle and the particular portion of the extension mechanism are connected in a telescoping relationship.

8. The hand truck of claim 5, wherein:
the particular portion of the extension mechanism is slideably mounted, in a nested relationship, with at least a portion of the hand truck frame.

9. The hand truck of claim 8, wherein:
the portion of the upper cart handle, the particular portion of the extension mechanism, and the portion of the hand truck frame are connected in a telescoping relationship.

10. The hand truck of claim 1, wherein:
the extension mechanism is adapted to slide between:
a first position in which the secondary wheel assembly is spaced apart from the primary wheel assembly by a first distance, and
a second, extended position in which the secondary wheel assembly is spaced apart from the primary wheel assembly by a second distance, the second distance being greater than the first distance;
the extension mechanism comprises a first elongated extension member and a second elongated extension member that is spaced laterally apart from the first extension member; and
the hand truck comprises a connecting member that connects a portion of the first extension member to a portion of the second extension member so that, as the extension mechanism slides from the first position into the second, extended position, the first and second extension members slide in tandem relative to the hand truck frame.

11. The hand truck of claim 10, wherein the connecting member comprises the secondary wheel assembly.

12. The hand truck of claim 10, wherein:
the first extension member is mounted in a telescoping relationship with a first portion of the hand truck frame; and
the second extension member is mounted in a telescoping relationship with a second portion of the hand truck frame.

13. The hand truck of claim 12, wherein:
the first extension member, the second extension member, the first portion of the hand truck frame, and the second portion of the hand truck frame are substantially tubular.

14. The hand truck of claim 1, wherein:
the handle comprises a grip;
the handle is adapted to be selectively moved between:
a first position in which the handle is positioned to allow a user, who is standing in an upright position, to operate the hand truck when the hand truck is in the hand truck orientation; and
a second position in which the handle is positioned to allow a user, who is standing in an upright position, to operate the hand truck when the hand truck is in the cart orientation.

15. The hand truck of claim 14, wherein when the handle is in the first position, the handle is mounted to slide relative to the hand truck frame.

16. The hand truck of claim 15, wherein, when the handle is in the second position, the handle is attached to the secondary wheel assembly.

17. The hand truck of claim 1, further including:
a lower cart handle disposed adjacent the lower end of the frame, the handle configured to rotate between:
a first position in which the lower cart handle is substantially parallel to the frame; and
a second position in which the lower cart handle is substantially parallel to the nose plate.

18. A hand truck comprising:
a hand truck frame;
a nose plate disposed adjacent a lower end of the frame;
a plurality of primary wheels disposed adjacent the nose plate;
at least one secondary wheel disposed adjacent an upper end of the hand truck frame; and
an extension mechanism that is adapted to allow a user to selectively adjust a distance between the plurality of primary wheels and the at least one secondary wheel.

19. The hand truck of claim 18, wherein the at least one secondary wheel comprises a plurality of secondary wheels.

20. The hand truck of claim 18, wherein the extension mechanism is adapted to:
selectively adjust the distance between the plurality of primary wheels and the at least one secondary wheel when the hand truck is in a substantially vertical, hand truck orientation; and
selectively adjust the distance between the plurality of primary wheels and the at least one secondary wheel when the hand truck is in a substantially horizontal, cart orientation.

21. A hand truck comprising:
a frame including a first frame member, and a second frame member spaced laterally apart from the first frame member;
a nose plate disposed adjacent a lower end of the frame;
a plurality of primary wheels disposed adjacent the nose plate;
at least one secondary wheel disposed adjacent an upper end of the frame;
an extension assembly, comprising:
a first elongated extension member slidably mounted with the first frame member, and a second elongated extension member slidably mounted with the second frame member;
wherein the extension assembly is adapted to slide between:
a first position in which the plurality of primary wheels are spaced apart from the at least one secondary wheel, and
a second, extended position in which the plurality of primary wheels are spaced apart from the at least one secondary wheel by a second distance, the second distance being greater than the first distance;
a connecting member that connects a portion of the first extension member to a portion of the second extension member; and
a handle comprising a grip portion, the handle slidably mounted with the extension assembly, wherein the handle is configured to selectively slide between:
a first position in which the grip portion is spaced a first distance from the nose plate; and
a second, extended position, in which the grip portion is spaced a second distance from the nose plate, the second distance being greater than the first distance.
